(19) United States
(12) Patent Application Publication
(10) Pub. No.: US 2005/0162268 A1
(43) Pub. Date: Jul. 28, 2005

(54) Digital video surveillance

(75) Inventors: Gene A. Grindstaff, Decatur, AL (US); Sheila G. Whitaker, Gurley, AL (US)

Correspondence Address: BROMBERG & SUNSTEIN LLP, 125 SUMMER STREET, BOSTON, MA, 02110-1618, US

(73) Assignee: Integraph Software Technologies Company, Las Vegas, NV (US)

(21) Appl. No.: 10/991,093

(22) Filed: Nov. 17, 2004

Related U.S. Application Data
(60) Provisional application No. 60/520,967, filed on Nov. 18, 2003.

(51) Int. Cl. G08B 1/00

(52) U.S. Cl. 340/531; 340/506; 348/153

(57) ABSTRACT

A control system for use with one or more video surveillance cameras forming a video surveillance system. The control system includes a video database module wherein a database entry includes at least one sensor condition defining an alarm state for each camera. Additionally, there is an alarm condition module that receives one or more sensor signals from one or more sensors associated with a camera and retrieves the sensor condition defining an alarm state for the camera. The alarm condition module outputs an alarm signal if the alarm condition module determines that the one or more sensor signals meets the one or more sensor conditions. The control system is modular and may be distributed in a network environment. The control system also monitors the network bandwidth and can adjust the throughput of digital data representing the digital images in order to avoid any bandwidth limitations.

### PRIORITY

The present application claims priority from U.S. provisional application No. 60/520967 filed on Nov. 18, 2003 and having the title “Digital Video Surveillance.” This provisional application is incorporated by reference herein in its entirety.

### TECHNICAL FIELD AND BACKGROUND ART

The present invention relates to digital video surveillance and more particularly to a digital video surveillance system capable of integrating with a pre-existing surveillance system without the need for rewiring the network connections.

Prior art surveillance systems that are to be installed with legacy surveillance systems require complete network rewiring. This is especially true if the legacy system includes analog cameras and the new system is digital. In addition to rewiring all of the cameras, the sensors that trigger the cameras need to be rewired. Trigger sensors are sensors that coupled to a camera that indicate that an event has occurred. For example, a trigger sensor may be a contact switch that is attached to a door, that when the door is opened causes an alarm. Having to rewire all of the cameras and all of the trigger sensors in a surveillance system can be extremely time consuming and costly especially on large scale systems. Further, expansion of the system once it is wired is difficult, if not impossible. Adding additional cameras and sensors can require the entire system to be rewired.

Additionally, prior art surveillance systems do not provide for continuous monitoring such that the system will automatically shift between a normal condition state and a configurable alarm condition state wherein images from different cameras are recorded and stored depending upon the state. Still further, the prior art systems do not allow the user to define the alarm conditions which will trigger the storage of image information. Prior art systems may include trigger sensors, but do not allow the user to define the threshold parameters that will cause the trigger sensors to set off an alarm. Nor do these prior art systems allow the user to combine different trigger sensors and different parameters for the trigger sensors in combination in order to set an alarm condition. Further, users of the prior art systems cannot create an alarm condition by selecting trigger sensors and selecting parameters for the trigger sensors.

Additionally, prior art video surveillance systems are not modular and are not designed for a distributed architecture. For example, if the video display section of a prior art video surveillance system fails then the system would also fail to record images.

### SUMMARY OF THE INVENTION

The digital video surveillance system includes a control system comprising an alarm condition module, display module, a video database and video recording module. The video database includes database entries for each camera within the video surveillance system and also includes an entry for an alarm condition for each camera. The alarm condition may be different for each camera and is dependent on the trigger sensors that are associated with the camera. Different sets of triggers sensors and different parameters for each trigger sensor may be selected to create an alarm condition. Thus, complex conditions can be defined for an alarm by allowing the user to define compound alarm sets in the video database. A user may even select and set a logical condition for each alarm condition including (and, or, greater than, equal to, etc.) between two or more sensor signals. Further, a user may select and set a parameter value associated with a sensor signal. The parameter value may be a threshold value. For example, an alarm may be set if the temperature is greater than 70 degrees. The user can make these changes using a user interface module and can also select one or more cameras so as to cause the display module to display images from the selected cameras on a display device.

The control system continuously monitors the sensors associated with the cameras and operates in two distinct states of operation for the cameras. The alarm processing module causes the system to operate in a normal state until an alarm condition arises based upon the receipt of one or more sensor signals associated with a camera. The system then enters an alarm state for that camera if the sensor signals meet the alarm conditions associated with the camera. The alarm state causes video images from the camera associated with the alarm to be recorded and saved to associated memory by the video recorder module. Typically, an indicia that an alarm has occurred is provided by the control system to the display device. This indicia may take the form of changing the color of the window displaying the camera images on the display device, to text presented on the display screen to an audible alarm. Further, if images from a particular camera are not presented on the display device and the sensors for that camera indicate that there is an alarm condition, the images will be added to the display device. After a camera has entered an alarm condition state, the user interface module allows a user to change the state associated with a given camera.

The system integrates with legacy video surveillance equipment without the need for rewiring the trigger sensors and rewiring all of the network connections. The system which is digital from end to end can integrate with legacy analogy systems by adding in A/D converters and employing the same PLC (programmable logic controllers) that monitor the trigger sensors.

The system is modular and may be distributed among multiple servers. The system may employ DCOM or another distributed architecture so that the various modules can run on separate machines over an existing computer network. This reduces the need for wiring and can provide added access control. Thus each module includes a network component and the modules may be located at different remote locations. This modular approach also allows the system to continue to function even if one of the modules becomes corrupted or fails. Additionally, the system can evaluate the amount of data that is being transmitted through a network and can give priority to image data that is associated with a camera that is having an alarm condition.

Because the system is modular, the recording and display components operate independently, such that if the display module failed, recording of the images would continue.

The system's modularity allows the system to be built into a larger system by combining clusters of the software modules that can logically be divided into function or location. Thus, several buildings could each have a video surveillance system, but the whole system could be monitored and controlled from one or more control points.

### BRIEF DESCRIPTION OF THE DRAWINGS

The foregoing features of the invention will be more readily understood by reference to the following detailed description, taken with reference to the accompanying drawings, in which:

FIG. 1 is block diagram showing the hardware employed in one embodiment of the digital video surveillance system;

FIG. 2 is a block diagram showing the modules and communication between modules of the software employed in one embodiment of the digital video surveillance system;

FIG. 2A is a block diagram showing one embodiment of the modular system in a networked environment;

FIG. 3A-3B shows a flow chart of how the software modules operate;

FIG. 4 shows the interaction of the alarm and normal conditions;

FIG. 5 shows one embodiment in which there are three modes of operation for the normal condition;

FIG. 6 shows an embodiment in which different numbers of cameras are in an alarm condition;

FIG. 7 is a screen shot of the graphical user interface wherein one of the cameras that is displayed is in an alarm state; and

FIG. 8 is another screen shot of the graphical user interface wherein one of the cameras that is displayed is in an alarm state.

### DETAILED DESCRIPTION OF SPECIFIC EMBODIMENTS

In the following disclosure and the appended claims the term “module” shall apply to both software embodiments and hardware embodiments, as well as, combinations of software and hardware, unless the context indicates otherwise.

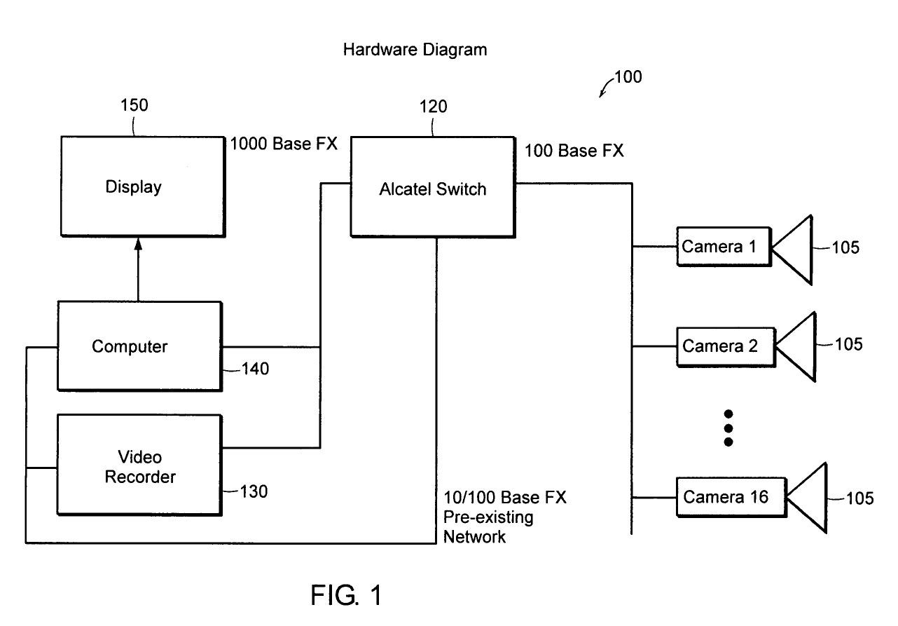

FIG. 1 is block diagram showing the hardware employed in one embodiment of the digital video surveillance system 100. The digital video surveillance system 100 includes one or more cameras 105 that are networked together and that incorporate one or more trigger sensors (not shown). The digital video surveillance system 100 may be combined with a legacy system without having to rewire the network or requiring new contacts for the trigger sensors. The pre-existing legacy network may be used. In exemplary FIG. 1, the system includes sixteen digital cameras 105 that are connected together over a 100 Base FX Ethernet/fiber network which is part of a legacy system. A multi-mode switch such as an Alcatel Omni Stack 6100 fiber switch 120 is employed for routing the signals between different networks. The legacy system includes a 10/100 Base FX network. Newly added to the legacy system is a 1000 Base FX connections. Both networks are coupled to a digital video recorder 130 and also to computer 140 which receives in the images and allows a user of the system to control the display of the cameras on a display device 150. The computer 140 also has software that is added for receiving in the digital images over the network, processing the digital images, allowing the user to display the images and monitoring one or more trigger sensors that are associated with the cameras.

The present invention may also integrate with an analog monitoring system, however each camera would be coupled to an analog-to-digital converter for converting the output images to a digital data stream or the multi-mode switch may have an integrated analog to digital converter. Further, the system would account for the time division multiplexing of the analog images of the legacy system.

Different networking options may also be employed other than fiber channels. For example, a phone network may be used either as the new network or as the legacy network, but the network is preferably partitioned such that the data and voice connections are separate.

Preferably in the video surveillance system, the video recorder and the computer should be coupled to the backbone of the newly added high speed network in order to compensate for digital data bandwidth issues from the multiple cameras.

It should be understood by one of ordinary skill in the art that the system shown in FIG. 1 is exemplary and may be expanded, as the system is modular to include more cameras and more computers that are networked together.

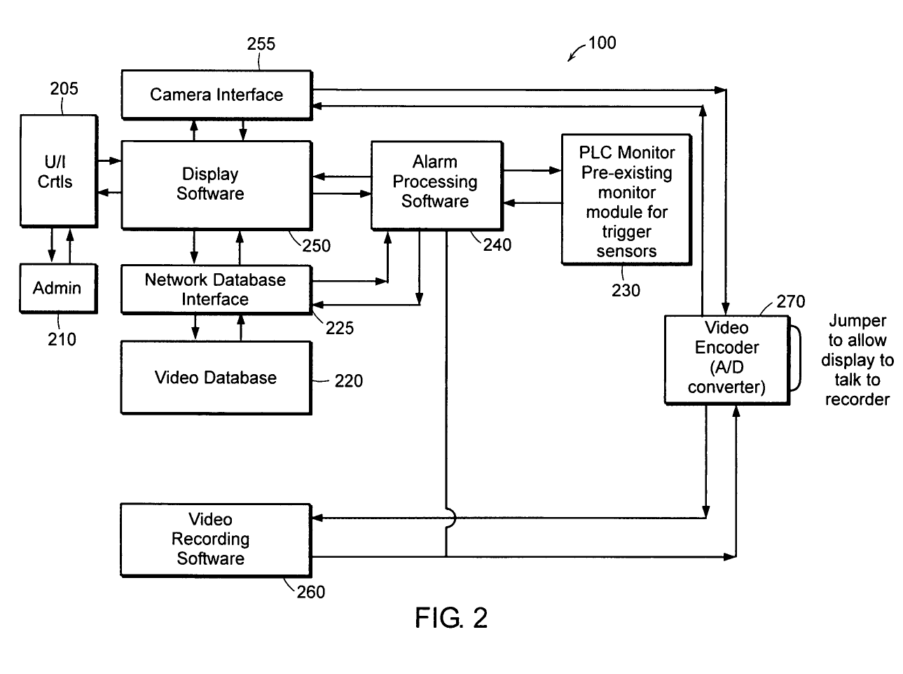

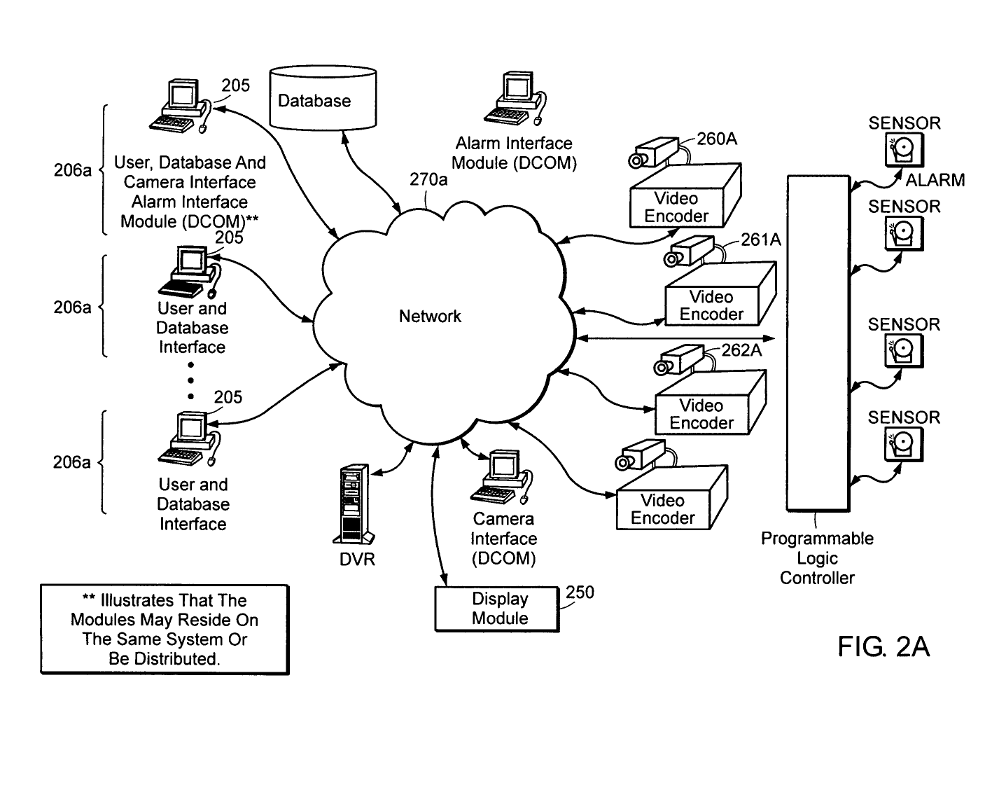

FIG. 2 is a block diagram showing the modules and communication between modules employed in one embodiment of the digital video surveillance system 100. The system is very modular and the modules may be distributed across many computers that are networked together. The digital video surveillance system includes an administration module 210 which allows a user to set-up the system. The administrator can changes parameters within a database file which is identified as the video database 220 in FIG. 2. The database 220 is coupled to a network database interface 225 such as a Microsoft DAO (data access object) interface or a Sequel Server object interface. The video database 220 includes a file or set of files that are utilized by an administration program 210. The database 220 includes a listing of the cameras, a listing of each camera's location, and an alarm setting for the camera. The database 220 may also include a table of access rights for operators of the system. The administrator may select the cameras that are to be displayed. For example, if the system includes twenty-five cameras, the administrator may assign privileges such that only sixteen cameras are available for a particular user. The administrator may also set conditions for an alarm. Alarm conditions can be simple conditions such as the closing of a switch for a particular trigger sensor that is associated with a camera, or alarm conditions may be a complex concatenation of events. For example, a camera may have multiple sensors associated with the camera including a temperature sensor, a contact sensor for a door, and a light sensor. As an example, the administrator may indicate that an alarm will occur when the contact sensor for the door is released (the door is opened) and also when the temperature within the room reaches 72 degrees Fahrenheit. Thus, if only one of the conditions occur, there will be no alarm.

As previously stated, each of the cameras is coupled to one or more trigger sensors. Standard within the video surveillance industry is the use of a PLC (programmable logic control) module 230. The PLC module 230 monitors the status of the trigger sensors. The present invention as shown in this embodiment, accesses the PLC module's information. This information is retrieved by an alarm processing module 240. Either the alarm processing module or the PLC module includes an interface that can translate the sensor signal status into a predefined software protocol. The alarm processing software module 240 also accesses the video database 220 through the network database interface 225. As such, the video database 220 may be located on a remote computer. Similarly, each of the various modules is designed for a distributed architecture and therefore, the modules may be located on different computer systems. When the alarm processing module 240 accesses the database 220, the alarm processing module 240 obtains the alarm conditions associated with each of the cameras and the associated trigger sensors. When the status of a trigger sensor changes, the alarm processing module 240 compares the condition set for an alarm with the change in the trigger sensor's status that is obtained from the PLC monitor module. If an alarm condition arises, the alarm processing module 240 sends an alarm message to the display software module 250. The display software module 250 interfaces with a camera interface module 255. The camera interface module 255 is capable of integrating with a pre-existing camera interface and is also capable of receiving camera information directly from the cameras. In one embodiment, the camera interface 255 is an Active X control, but different manufacturers use different interface protocols and the interface protocols may vary. The camera information (images) is passed to the display module 250. The display module 250 then displays the images captured by the camera on the user's display in a window. The user may control the number of cameras that are displayed, whether to record each camera, and the mode of operation. The display module 250 also receives input from the alarm processing module 240 which will indicate if a camera is in an alarm state. If the camera is in an alarm state, the display module 250 will cause the display to show the images from the camera with an indicia that there is an alarm, such as, a border around the camera window. In some embodiments, the window for the camera may flash or other indicia may be displayed to indicate that there is an alarm condition. For example, an alarm may cause the display of the camera to be redrawn into a larger window on the display device. The display module can also change the resolution of the images depending on whether the images are associated with an alarm state or are in a normal state. If an alarm state is detected, the display module can send the images at a higher resolution than for the cameras in a normal state. Further, a user may also use the display module to select other cameras in a normal state that the user wishes to have displayed at a higher resolution and thus, the display module will transmit the images to the display at the higher resolution.

Each of the modules within the system includes the ability to couple to the other modules within the system through a network as shown in FIG. 2A. Thus, each module is equipped to transmit and receive data communications using a networking protocol, such as TCP/IP. The ability to distribute the modules in a network allows the modules to be placed in different locations, but still access information from the other modules. Additionally, different users can access images from different locations by having the user interface controls 205 situated on a computer associated with each user. The system may have a plurality of monitoring stations 206A at remote locations and each user can independently select the cameras 260A, 261A 262A that the user wishes to view.

Further, the modules are designed as a system, and the system monitors the network bandwidth. By monitoring the network bandwidth, the system can automatically give priority to images from cameras that are associated with an alarm condition so that a user viewing a display device 206A does not loose any information about an alarm due to bandwidth constraints in the network 270A. Further, bandwidth constraints can be accommodated by reducing the resolution of the images that are transmitted, but providing a higher resolution image from any camera 260A that is associated with an alarm state. Under extreme conditions, the display module 250 can stop the transmission of images that are not in the alarm state to accommodate network bandwidth limitations. In certain embodiments, the bandwidth of the system is predetermined and thus there is no need to actively monitor the bandwidth. However, the display module 250 still accounts for the bandwidth of the images that are being sent out into the network and monitor the percentage of bandwidth being utilized. Thus, based on the percentage of bandwidth that is utilized, the display module can determine the resolution of the images that are to be transmitted. The system thus, automatically and dynamically adjusts to the bandwidth conditions based on the resolution of the images being transmitted, the number of requested cameras, the number of users that are accessing images and the known network bandwidth.

Since the system is modular, command and control of the system through the administration module can be maintained at a remote location.

Also due to the system's modularity, the display system and the recording system are independent. If the display system fails, the digital video surveillance system is still capable of recording information. There are separate data paths to both the recording software and the display software. In the embodiment that is shown in FIG. 2, the video recording software 260 is legacy recording software. However, the invention disclosed is not limited to such an embodiment. A new recording program may be integrated into a legacy system. Further, the camera used in the system is shown as an analog camera. The camera is coupled to a video encoder which includes a D/A converter 210. In FIG. 2, the D/A converter is the only hardware that is present. All of the other modules are software components. The video encoder 270 also packetizes the data and converts the image data into a format capable of HTTP display. Further, the encoder accounts for any time division multiplexing of image information.

In the embodiment that is shown, the video encoder is a video encoder manufactured by Axis Communications. The video encoder includes at least two sensor inputs, two control inputs, a control output and a sensor output. In order to use the legacy video recording software, the control output is fed back into a sensor input. The alarm processing software generates a control signal indicating that an alarm condition has occurred to the control input of the video encoder. The legacy recording software program expects a sensor signal as an indication to begin recording. Thus, by using a control signal and feeding the control signal in a loop-back fashion as the input of a sensor input, the control signal from the alarm processing software will cause a sensor signal to be output and received by the recording software and recording will begin. This jumper allows recording to be controlled without having to create an additional protocol signal. Additionally, the control signal to the video encoder can cause the analog video signal to be sampled and converted to different sized digital formats, since the video recorder expects a sensor signal output from the video encoder to change formats.

The user of the system can control and change the status of a camera from an alarmed status to normal status by using the user interface 205 and indicating acknowledgement of the alarm condition.

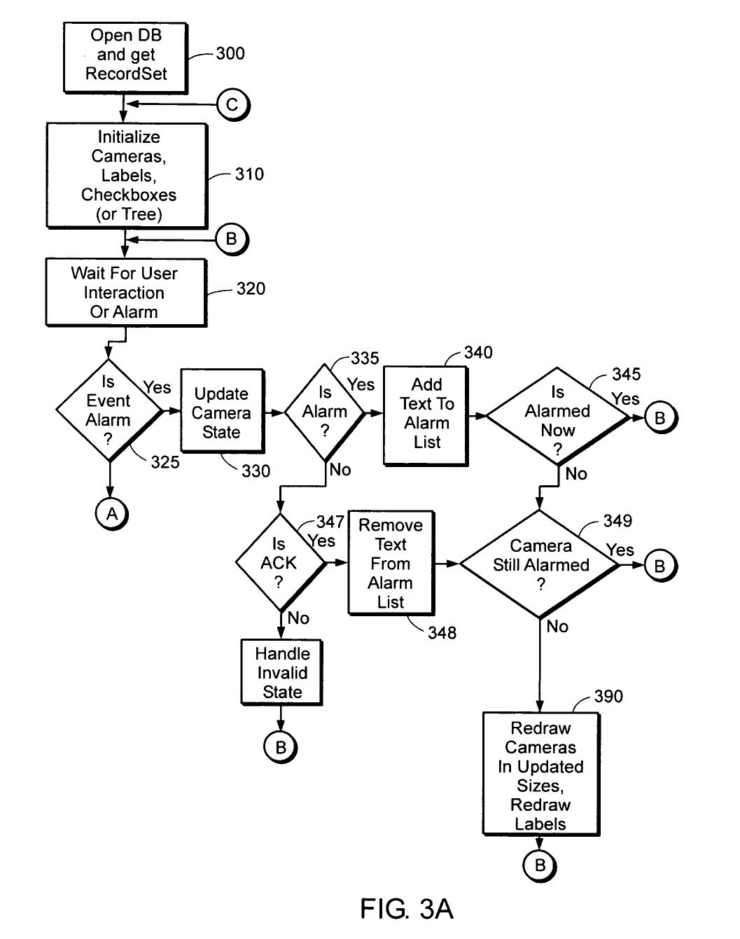

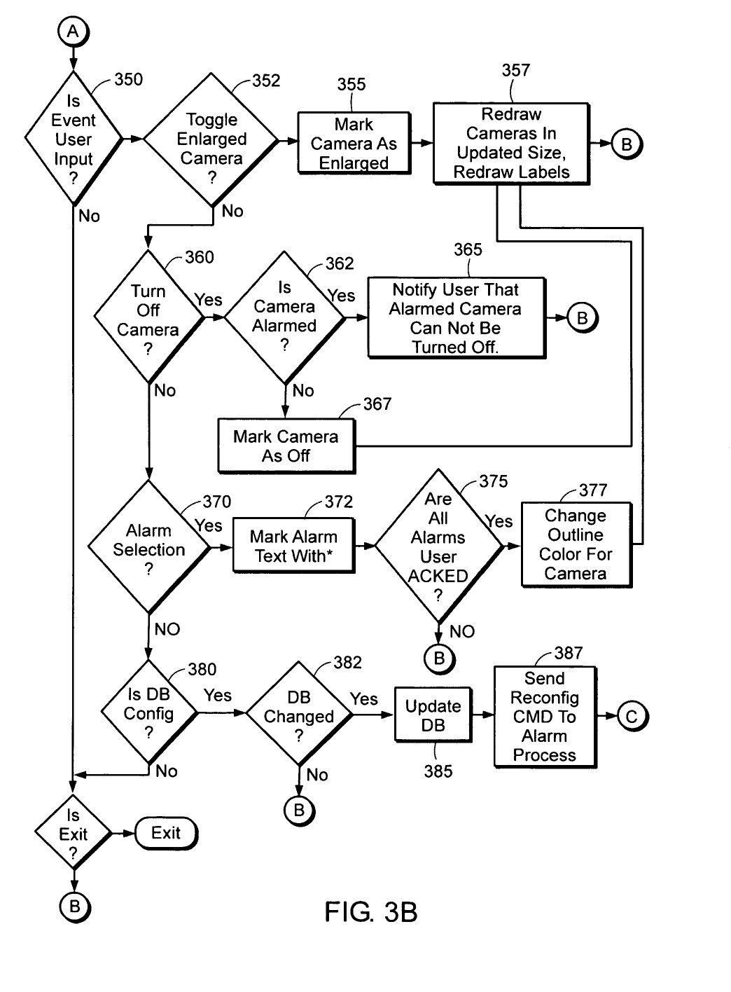

FIG. 3A-3B shows a flow chart of how the software modules operate. First the database is accessed and the record set is retrieved 300. The record set includes the names and locations of each of the cameras along with the alarm conditions for each of the cameras. Alarm conditions may include relative evaluations such as greater than, less than and equal to. Further, an alarm condition may include a settable parameter, such as a threshold level. The alarm processing module retrieves the record set. Next the cameras are initialized 310. Each of the cameras is turned on and is set to a normal setting. The triggers sensors are also read and the alarm processing software module compares the signal from the trigger sensor(s) with the record set information. The system then waits for user interaction or for an alarm to occur 320. When an event occurs, the system checks to see if it was an alarm 325. If it is an alarm, the camera state is updated 330. The display software indicates that an alarm has occurred by including some indicia on the display. For example, the window displaying the camera images may be enclosed with a different colored border. A status variable for the camera is also updated to indicate that an alarm has occurred. If it is an alarm, text is added to the alarm list indicating the type of alarm 340. For example, the trigger sensors may be temperature sensors, contact sensors, smoke detectors etc. The alarm may indicate that there is a fire, a rise in temperature, an intruder or other type of alarm. The system then determines if the alarm is occurring at present. A check of the status of the trigger sensors is performed 345. If the alarm is still going on the system returns to point B on the flow chart. If the event is not an alarm then the system goes to point A on FIG. 3B. The system then queries whether the event is user input 350. If the answer is no the system either exits if the event is an exit request or returns to point B. If the event is user input, the system checks to see if the user has requested to increase the size of a view of a particular camera 352. If the answer is yes the system changes a variable and marks the camera as enlarged 355. The system then redraws the camera into a larger sized window and updates and redraws the labels 357. The system then continues onto point B. If the user input is not to enlarge the view of a camera, the system inquires if the user desires to remove the images of the camera from the display 360. If the user does want to remove the images of camera, the system inquires whether the camera is in an alarmed state 362. If the camera is in an alarmed state, the user is notified that the user cannot remove the images from the display of an alarmed camera 365. The system then returns to point B. If the camera is not alarmed, the camera is marked as being off and the camera is removed from the display window and all of the remaining camera windows are resized to fit within the display 367. If the user has not requested to turn off the images from the camera, the system inquires whether the user has requested to change the status of an alarm 370. If the answer is yes, the visual display marks the alarmed camera window with indicia that the alarm has been acknowledged, but the alarm is still active 372. The system then inquires if all of the camera alarms have been acknowledged 375. If the answer is yes the outline (border) of the window for the camera is changed from the color associated with an alarm condition to that of a normal condition, but the indicia such as an asterisk remains to indicate that the camera/trigger sensors are still in an alarmed state 377. The system then resizes and redraws the windows and the system returns to point B. If all of the alarms have not been acknowledged by the user, the system returns to Point B.

If the user has not selected to change the status of the alarm, the system then checks to see if the request by the user if for reconfiguring the database 380. The system at this point may check the status of the user to see if the user has been granted the privilege to change the database. If the answer to this inquiry is yes, the system looks to see what the user wishes to change 382. The user can change the alarm settings, including the alarm constraints, the name of a camera, and which cameras are being displayed, for example. If the user does not change a setting in the database the system returns to point B. If the user does make a change to the database then the data base is updated 385. A command is sent to the alarm processing software module which indicates that the database has been updated and the recordset is again downloaded to the alarm processing software module 387. The system then returns to point C. It should be understood that an administrator or user with the proper privileges can set the alarm such that an alarm requires a combination of events to trigger an alarm. For example, an alarm may be sounded only if a fire occurs and a flood occurs. In such a case, a temperature sensor may have to reach a particular temperature and a water level indicator may need to reach a particular level before an alarm occurs. An authorized user has control to change whether one of or more sensors will cause an alarm and the threshold parameter for each sensor.

Returning to FIG. 3A, if the event is an alarm 335, the user may acknowledge the alarm. If the user acknowledges the alarm 347, the system removes text from the alarm list display 348. The system then inquires whether the camera is still alarmed 349. If the camera is still in an alarmed state (the trigger sensors are set such that an alarm condition exists), then the system returns to point B. If the camera is no longer in an alarmed state the display software redraws the windows displaying the camera's images on the display screen along with updated labeling 390, i.e., returning to labeling indicative of the normal state.

It should be clear that the flow charts of FIG. 3A and 3B operate as a continuous loop.

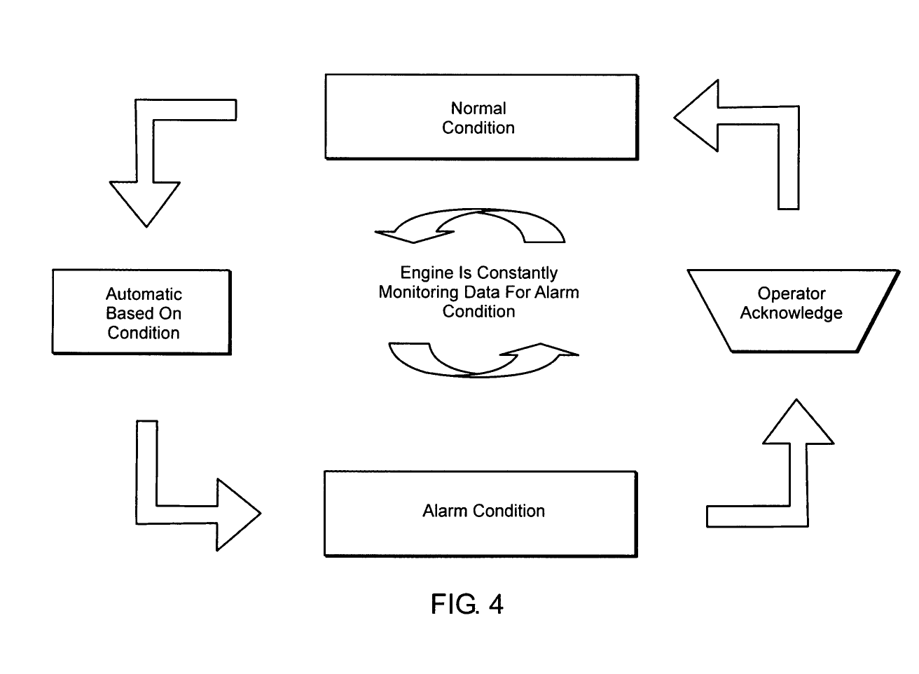

FIG. 4 shows the interaction of the alarm and normal conditions. The system operates under a normal condition state for much of the time. The software routine as explained with respect to FIGS. 3A and 3B continues to monitor the trigger sensors for an alarm condition. When an alarm condition occurs, the system automatically goes into an alarm condition state. When the system is in an alarm condition state, the system will remain in that state until the user acknowledges the state. The user of the system is provided with a graphical interface on a display device that shows one or more windows in which the images from a camera are displayed. When an alarm occurs, the graphical window is updated with text that indicates that an alarm has occurred along with a border around the window, such as a red border. If the images from a camera are not presently displayed and that the sensors for that camera experience an alarm condition, a new window will be provided for that camera. The user can then acknowledge that an alarm is occurring. This takes the system out of the alarm mode and resets the system back into the normal condition mode. When the acknowledgement occurs, the window for the camera which was having the alarm will be reset, such that the text will no longer indicate that an alarm is occurring, and the border around the window is changed back to the normal condition color. If the user acknowledges an alarm, and the alarm condition still exists an asterisk or other indicator will be marked on the graphical user interface which indicates that the sensors are still in an alarmed condition state, however the system will return to a normal condition state.

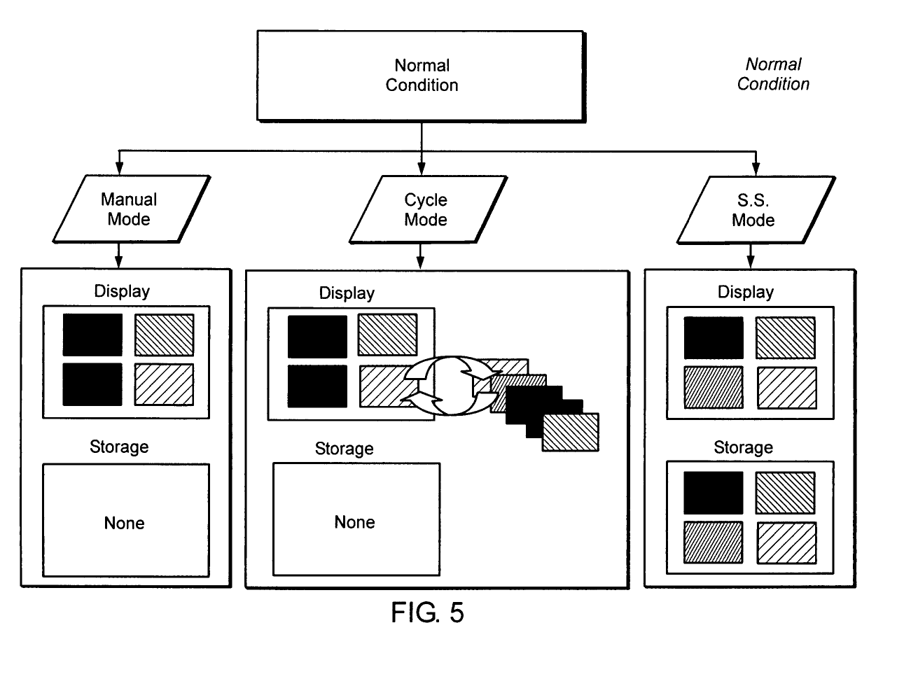

FIG. 5 shows the three modes of operation for the normal condition. A user can determine which cameras the user wants displayed and what information that the user would like stored. For example, in manual mode 510, the user selects the cameras to have displayed. The user may select one or multiple cameras to display. In manual mode 510, the user monitors the system and in the normal condition none of the images from any of the cameras are recorded and stored to memory. If the user selects the cycle mode 520, the user can select one or more cameras to have permanently displayed on the display, but at least one of the window cycles through the remaining cameras. For example, if there are eight possible cameras, the user may select to permanently display cameras 1-3 (521) and in the fourth window 525 the system will cycle through cameras 4-8. In the cycle mode, the system does not record and store information to a memory storage device. In the third mode, which is marked S.S. 530 the display operates much like the manual mode, but all the information from all of the cameras is recorded to memory 540 in digital form. The number of cameras shown in the Figs are provided for illustrative purposes and the system is not limited to a fixed number of cameras.

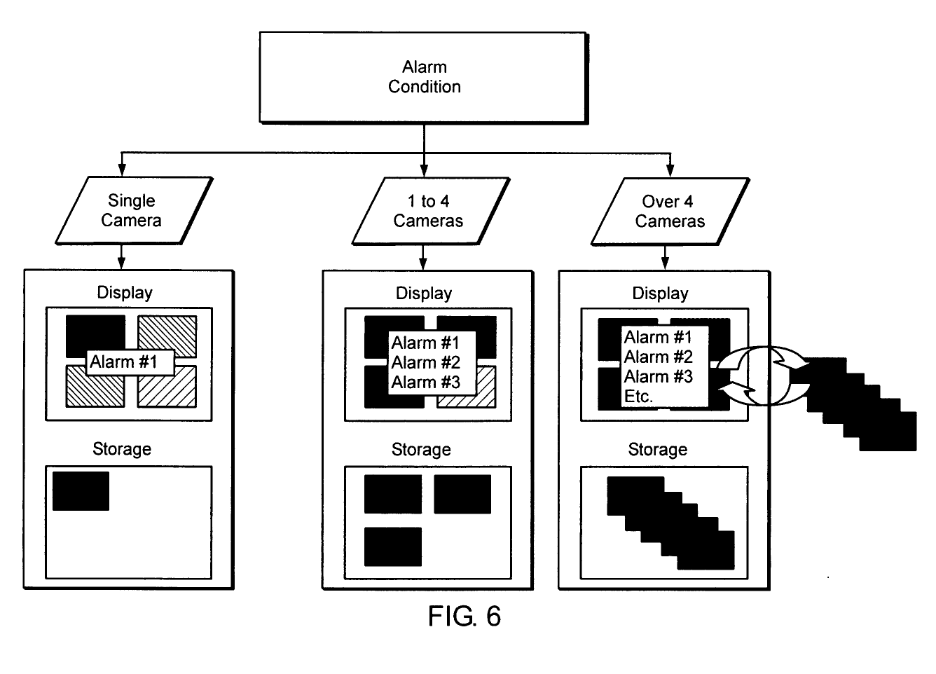

FIG. 6 shows the display screen 610 A,B,C and storage 620 A,B,C when different numbers of cameras are used under an alarm condition. When a single camera is used and an alarm condition arises the display 610A changes such that a textual indicator is provided, for example “alarm #1” and the window for the camera changes its border color. Other indicia might be used to indicate that an alarm has occurred such as having the picture flash or the border flash. During the alarm condition state, each camera that has an associated alarm condition will have its images stored to memory 620A. If the display window 610B is sized such that only four cameras are capable of being shown and there are no more than four cameras in the system, the display 610B will show each of the cameras and when an alarm occurs for one or more of the cameras one or more indicators that an alarm is occurring will be provided. For example, in the Fig., cameras 1-3 (612B) are each having an alarm. A textual message is provided and each of the camera windows for which there is an alarm has a changed border color. When the alarm condition occurs, the system automatically begins to record the camera images. If there are more than four cameras and only four cameras are capable of being displayed due to sizing of the windows on the display device 610C, one or more of the windows 615C will rotate. If an alarm occurs for one of the cameras that is not being displayed, a window will be initiated which will display the camera and will have some indicia that an alarm condition is occurring. If more than four cameras experience alarm conditions at the same time, the display 610C will rotate the images in different windows so that a user can view each alarmed camera. Again it should be understood that the number of cameras that are referenced in the Figs. is for illustrative purposes and the system does not have a fixed number of cameras nor is the camera limited to the number of camera images that can be displayed on a display device. For each camera that experiences an alarm condition, the digital images from the camera are stored in memory 620A, 620B, and 620C.

FIGS. 5 and 6 show the video images being cycled through if there are more images than space to display the images on the display device, however there are other methods for displaying the images in both the alarm and normal conditions. For example, the user may be allowed to page through a group of cameras. In other embodiments, the current images from a camera may be displayed based upon the cameras that have been either most frequently requested in the past or a camera that has been requested over a certain past time period. The software also allows a user to prioritize the cameras that will be displayed, so that a camera that is marked with a high priority will be the last image to be removed from the display in the event of an alarm condition. It should be understood by one skilled in the art that other variations for displaying the images from a camera can be used without deviating from the scope of the invention.

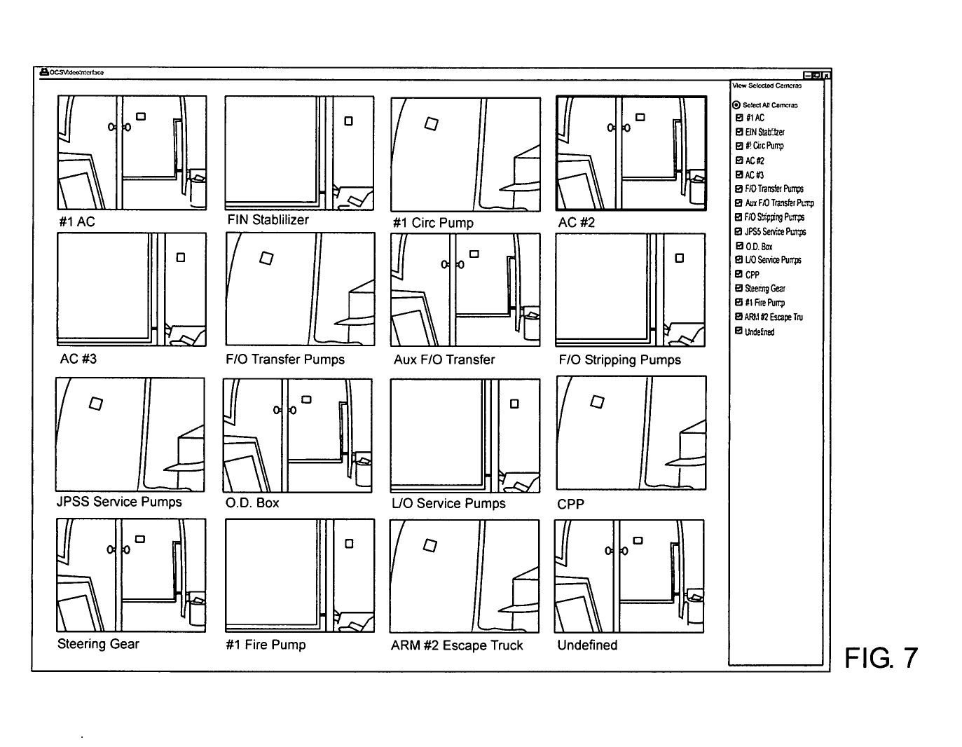

FIG. 7 is a screen shot showing the user graphical interface. In this embodiment, sixteen cameras are visible at the same time and one of the cameras AC #2 (710) in the upper right hand corner is experiencing an alarm. The alarm condition is identifiable because the border around the window for camera AC #2 (710) has changed. To the right of the screen each camera of the sixteen possible cameras that is available is listed along with a check box (720), which when checked indicates that images from the camera will be displayed. In this fig. “select all cameras” is selected and all sixteen cameras are displayed at the same time.

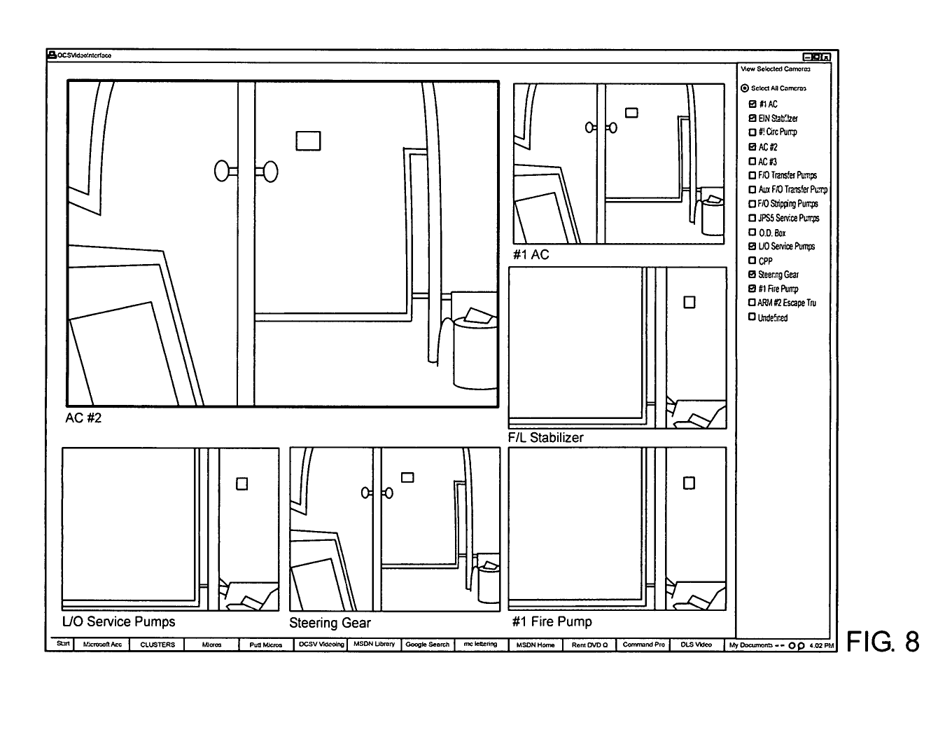

FIG. 8 shows a different screen shot. This screen shot shows that only six of the sixteen possible cameras are selected and displayed to the user. In this screen 710 AC #2 is experiencing an alarm condition. The screen 710 for AC#2 is increased in size indicating that it is in an alarm condition. By increasing the size of the image, the user can better identify the cause of the alarm. AC#2 can also be identified as experiencing an alarm condition because the border around its window 710 is changed to a different color than the border around the windows of camera's operating in a normal state.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

1. A system for use with one or more video surveillance cameras comprising:
a video database module wherein a database entry includes at least one sensor condition defining an alarm state for each camera;
an alarm condition module receiving one or more sensor signals from one or more sensors associated with a camera and retrieving the at least one sensor condition defining an alarm state for the camera;
wherein the alarm condition module outputs an alarm signal if the alarm condition module determines that the one or more sensor signals meets the one or more sensor conditions.

2. The system of claim 1, wherein an alarm state for a camera is defined at least by a plurality of sensor conditions.

3. The system of claim 1, further comprising:
video recording module wherein when the video recording module receives a signal representative of the alarm signal from the alarm condition module, the video recording module records one or more digital images from the camera.

4. The system according to claim 1, further comprising:
a display module for outputting an image produced by the camera to a display device along with an indicia that there is an alarm state associated with the camera.

5. The system according to claim 1, wherein the alarm condition module is in communication and receives the one or more sensor signal from a programmable logic controller.

6. The system according to claim 1 further comprising:
a user interface module for changing one or more sensor conditions defining an alarm state in the video database.

7. The system according to claim 6, wherein the user interface module allows an addition of one or more additional sensor conditions to a database entry.

8. The computer program product according to claim 1, wherein each module can communicate with one or more other modules over a network.

9. A method for operating a digital video surveillance system, the method comprising:
providing to a computer one or more sensor signals associated with a camera;
accessing from a database, a record for the camera wherein the record includes an alarm condition for the camera;
ascertaining if the alarm condition has been met using the sensor signals; and
if the alarm condition has been met, outputting an alarm signal.

10. A method according to claim 9, wherein the alarm condition is a logical combination of two or more conditions associated with one or more sensor signals.

11. A method according to claim 9, wherein the alarm signal causes images from the camera to be stored in memory.

12. A method according to claim 9, further comprising displaying images from the camera on a display device.

13. A method according to claim 9, wherein if an alarm signal is output, causing indicia of an alarm to be presented in association with the image for the camera on the display device.

14. The method according to claim 9, wherein there are a plurality of cameras in the video surveillance system wherein each camera is associated with at least one sensor.

15. The method according to claim 14, wherein images from a plurality of cameras are displayed on the display device; and
if an alarm signal is output, the image for the camera associated with the alarm signal is increased in size.

16. The method according to claim 9, further comprising:
receiving an instruction that selects a record from the database; and
receiving a separate instruction changing the alarm condition for a camera.

17. The method according to claim 16, where the alarm condition includes one or more parameter values associated with a sensor.

18. The method according to claim 16, wherein the alarm condition includes a logical reference between values associated with two or more sensor signals.

19. A control system operative with one or more cameras and one or more sensors to form a video surveillance system, the control system receiving a request for images from one or more of the cameras over a network having an associated bandwidth, the control system comprising:
a display module for receiving the request from the network and providing to the network an output of the requested images from the one or more cameras;
wherein the display module monitors available network bandwidth and adjusts the output to the network based on the available network bandwidth.

20. The control system according to claim 19, further comprising:
an alarm processing module for receiving at least one sensor signal from one or more sensors associated with the one or more of the cameras, wherein the alarm processing module determines if there is an alarm state for a camera based in part on the at least one sensor signal.

21. The control system according to claim 20 further comprising:
a video recorder module;
wherein the alarm processing module operates in a normal state until an alarm condition arises based upon the receipt of one or more sensor signals associated with a camera and then operates in an alarm state causing video images from the camera associated with the alarm to be recorded and saved to associated memory by the video recorder module.

22. The control system according to claim 19, further comprising:
wherein the output is adjusted by reducing resolution of one or more images from the one or more cameras.

23. The control system according to claim 20 wherein the output is adjusted by only transmitting to the network images from cameras that are in an alarm state.

24. A computer program product having computer code thereon for operation on a computer system, the computer code controlling a digital video surveillance system, the computer code comprising:
computer code for receiving one or more sensor signals associated with a camera;
computer code for accessing from a database a record for the camera wherein the record includes an alarm condition for the camera; and
computer code for ascertaining if the alarm condition has been met using the sensor signals and if the alarm condition has been met, outputting an alarm signal.

25. A computer program product according to claim 24, wherein the alarm condition is a logical combination of two or more conditions associated with one or more sensor signals.

26. A computer program product according to claim 24, further comprising:
computer code for causing images from the camera associated with the alarm signal to be stored in memory.

27. A computer program product to claim 24, further comprising:
computer code for displaying images from the camera on a display device.

28. A computer program product according to claim 24, computer code for causing indicia of an alarm to be presented in association with the image for the camera on the display device if an alarm signal is output.

29. The computer program product according to claim 24, wherein there are a plurality of cameras in the video surveillance system wherein each camera is associated with at least one sensor.

30. The computer program product according to claim 29, further comprising: computer code for displaying on the display device images from a plurality of cameras and if an alarm signal is output, the image for the camera associated with the alarm signal is increased in size.

31. The computer program product according to claim 24, further comprising: computer code for receiving an instruction selecting a record from the database; and computer code for receiving a separate instruction changing the alarm condition for a camera.

32. The computer program product according to claim 31, where the alarm condition includes one or more parameter values associated with a sensor.

33. The computer program product according to claim 31, wherein the alarm condition includes a logical reference between values associated with two or more sensor signals.

34. The control system according to claim 20, wherein the display module and the alarm processing module are networked together so that each module can be located at a different remote location.

35. A method for controlling a video surveillance system operating in a network having an associated bandwidth, the method comprising:
receiving a request originating from a location associated with a user interface in the network for transmission of images from one or more of a plurality of cameras from the video surveillance system;
obtaining the images from the one or more cameras wherein the images are composed of digital data;
determining if the digital data for the images to be transmitted exceeds an available bandwidth of the network;
reducing the digital data until the digital data no longer exceeds the available bandwidth of the network; and
transmitting the images to the location associated with the user interface.

36. The method according to claim 35 wherein the digital data forming the images is reduced by decreasing the resolution of the images.

37. The method according to claim 35 wherein the digital data is reduced by transmitting only images associated with an alarm condition.
